(19) United States
(12) Patent Application Publication
(10) Pub. No.: US 2011/0123719 A1
(43) Pub. Date: May 26, 2011

(54) Modification of Identification Signatures with an Applied Material

(76) Inventors: William G. Gnesda, Imperial Beach, CA (US); Thomas Huber, Imperial Beach, CA (US)

(21) Appl. No.: 12/622,920

(22) Filed: Nov. 20, 2009

(51) Int. Cl. B05D 1/14; B05B 5/025

(52) U.S. Cl. 427/463; 118/621

(57) ABSTRACT

A method of modifying radar, thermal, acoustic, and visual signatures of an object includes the application of flocking to the object. The flocking may be applied by an electrostatic flocking process. The flocking material may be constructed to include a radar absorbent material to increase the efficacy of the flocking material relative to the reduction and alteration of radar signature screening.

### BACKGROUND OF THE INVENTION

1. Field of the Invention

The present invention relates generally to radar obscuring technology and more particularly to a method to modify identification signatures of a given object.

2. Background Art

Electrostatic flocking is a process in which strands or particles of a cord material, (which is very often a synthetic fiber, such as nylon) are applied to a substrate. The object to be flocked is prepared as a substrate with an adhesive substance suitable for retaining the cord strands. The cord strands are typically prepared by chopping material into a length that is desired for a specific application. The strands are then applied to the substrate with a flock application machine.

The flock application machine operates by applying a positive charge to the flocking strands as they are expelled from the machine. The substrate surface is grounded, thereby establishing a negative charge relative to the charged flocking strands. The synthetic strands are therefore urged by the opposing charges of the strands relative to the substrate to align vertically on the substrate. When the flocking application process is complete, and the flocking machine is disconnected, the flocking strands are held in place on the substrate by the pre-applied adhesive, thereby yielding a soft, textured surface.

### SUMMARY OF THE INVENTION

An exemplary embodiment of the technology described herein is a method of modifying radar, thermal, acoustic, and/or visual signatures of an object (e.g., a vehicle) by applying flocking to the object. It is envisioned that the method may be used on military vehicles, equipment, and structures in combat areas. In this disclosure, radar, thermal, acoustic, and visual signatures, and any combination thereof, may be referred to collectively as “identification signatures.”

While any flocking process is acceptable for the technology described herein, the flocking will typically be applied by an electrostatic flocking process. The electrostatic process, in which a charge differential is applied to the substrate relative to the flocking material, provides a method in which a high percentage of the flocking particles are aligned vertically on the substrate. According to various embodiments of the technology, essentially all of the flocking particles are aligned vertically on the substrate.

Moreover, the flocking material and/or the adhesive may be constructed to include a radar absorbent material (sometimes referred to as RAM), to increase the efficacy of the flocking material relative to radar screening. Radar absorbent material is used to reduce the likelihood of radar identification of a given object by altering the appearance of the object on a radar screen. While there are no currently known materials that are completely invisible to radar, various materials absorb radar waves of a given frequency. A radar absorbent material may reduce the radar cross section of an object relative to a specific frequency. Different radar absorbent materials absorb different radar frequencies, but no material is known to absorb all radar frequencies.

The present method may include manufacturing the flocking strands that are to be used in the process to include energy absorbent material embedded in the strands, so that the flocking strands have a heightened ability to function as radar absorbent material. Materials that may be used to increase the radar absorbency of the flocking material include carbonyl iron particles prepared by the decomposition of iron pentacarbonyl, graphite and other semiconductive materials, ferrite, and carbon black. Alternatively, the radar absorbent materials may be added to an adhesive used to secure the flocking material to the object being flocked.

An advantage of the method disclosed herein is that it allows a user to modify the identification signatures of an object, so as to cause uncertainty in an operator of a surveillance system, thereby increasing the likelihood of survival of a target and those near it. Even a momentary hesitation in target identification on the part of a surveillance or weapons system operator may greatly enhance the chances of mission success.

Another advantage of the present method is that the flocking material of the present method also reduces the thermal signature of an object by providing a greatly increased exterior surface area. The greater capacity for heat dissipation alters the thermal signature of the object. Similar to the radar signature, the thermal signature of most heat-generating objects cannot be completely eliminated.

Still another advantage of the method is that the textured flocking surface alters any acoustic signature generated by the subject object. This is particularly beneficial for flocked vehicles. The flocking reduces not only sound generated by the vehicle itself, but also sounds attendant to the operation of the vehicle, such as those generated by objects coming into contact with the vehicle body or undercarriage while the vehicle is in motion (e.g., branches or loose rocks deflecting off the body of the vehicle). A reduced sound level leads to a reduced likelihood of acoustic identification.

Still another advantage of the method is that flocking reduces the light reflection of the object. A reduced light reflection presents a reduced and distorted visual signature to an observer, again reducing the likelihood of identification. Instilling even an element of doubt in the surveillance operator is a tremendous benefit. Using various battlefield colors with a digitally constructed pattern in conjunction with flocking may render the subject equipment unrecognizable to the naked eye, causing doubt and delay in the actions of an enemy.

These and other objects and advantages of the presently disclosed technology will become apparent to those skilled in the art in view of the description of the best presently known mode of carrying out the technology as described herein and as illustrated in the drawings.

### BRIEF DESCRIPTION OF THE DRAWINGS

FIG. 1 is a block diagram of an exemplary embodiment of a method of the technology disclosed herein.

### DETAILED DESCRIPTION

Systems and methods for modifying identification signatures are provided herein. One exemplary method disclosed herein is a flocking process that modifies the external physical characteristics of an object, thereby modifying the identification signatures of the given object. Modification of the identification signatures may cause uncertainty in an operator of a surveillance system, thereby increasing the likelihood of survival of a target object and those near the target. Even a momentary hesitation in target identification on the part of a surveillance system operator may greatly enhance the chance of survival of the target.

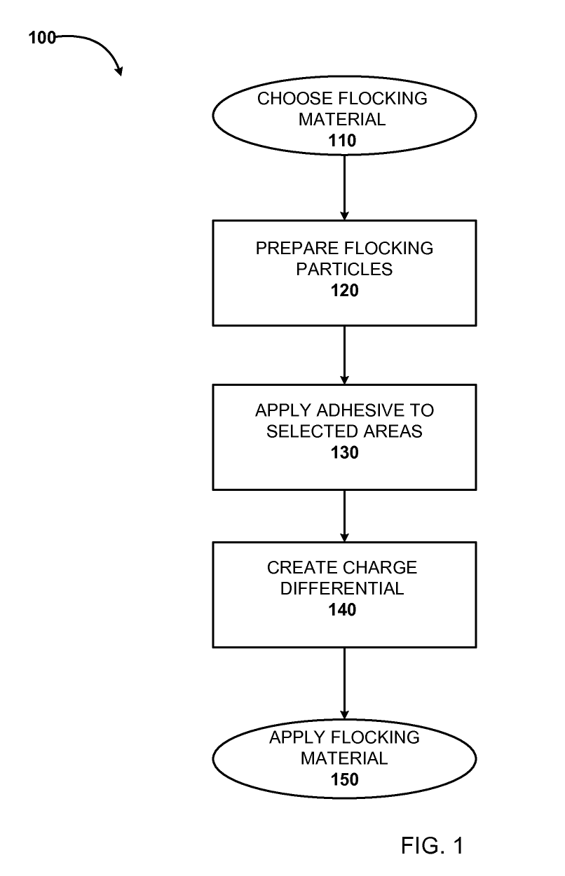

An exemplary method is outlined in the block diagram of FIG. 1. A basic flocking process has been modified to meet the requirements of the present technology. The following description is made with reference to FIG. 1.

An exemplary embodiment of the technology described herein is a method 100 of modifying the radar, thermal, acoustic, and visual signatures of an object (such as a vehicle) by applying flocking to the object. It is envisioned that the method may be used by military forces in combat situations.

The flocking may be applied by an electrostatic flocking process. There are other methods of flocking application known in the art, but electrostatic flocking may be used particularly for applications involving a metal surface.

In the electrostatic flocking process, the method 100 is initiated by choosing a flocking material 110 which may be in cord form. The material chosen will typically be polyester, nylon, or viscose, but any material that can be electrically charged may be selected as the flocking material. Factors that may be considered in the choice of flocking material include, but are not limited to, thermal characteristics, durability in heat and sunlight, color and color retention, and flame retarding capability.

A radar absorbent material may be included in the flocking material to increase the efficacy of the flocking material relative to radar screening. Various materials may be embedded in the flocking cord material so that the resultant flocking material has an increased ability to function as a radar absorbent material. Materials that may be used to increase the radar absorbency of the flocking material include but are not limited to carbonyl iron particles prepared by the decomposition of iron pentacarbonyl, graphite and other semiconductive materials, ferrite, carbon black and any combination thereof.

The flocking material that is to be applied may be prepared 120 by chopping synthetic cord material into pieces of a length desired for a given application. The length of the flocking material pieces is chosen according to the requirements of the subject application. The chopped flocking material will be referred to as flocking “particles” in this description.

It should be noted that the user may not in all cases need to chop the cord material. Some lengths of flocking materials are commercially available, and may be suitable for a particular application.

In some instances, multiple lengths of flocking material may be used in a single application. Different lengths may be applied in separate areas, or the lengths may be mixed to create an uneven surface. Typical lengths of prepared flocking materials generally range from 0.25 mm to 5.0 mm. It should be noted that radar absorbent material may be added to the flocking particles at any point in the method 100.

In order to retain the flocking particles in position on the object to be flocked, the surface of the substrate is prepared by applying a layer of adhesive material 130. In some cases, the adhesive will be applied only to selected areas of the substrate. The adhesive material may be an acrylic or epoxy adhesive.

The adhesive layer may be paint applied to the substrate, with the flocking particles applied before the paint has dried. Spray paints may be particularly useful in the method due to the ease and speed of application.

The adhesive chosen, whether it be an acrylic or epoxy adhesive or paint, may be chosen with certain performance characteristics in mind. The adhesive may be selected to have flexibility characteristics and color compatible with the substrate. Radar absorbent materials may also be added to the adhesive.

After the flocking material has been prepared, the object to be flocked must be readied. Nearly any object may be flocked, so long as it is capable of accepting an electrical charge. In a typical electrostatic flocking process, a charge differential is created 140 between the object to be flocked and the flocking material itself, so that the object to be flocked and the flocking material may have opposite surface charges. In many electrostatic flocking application schemes, the flocking material is expelled from a flocking gun with a positive charge. The object to be flocked is grounded, therefore providing the object substrate with a negative charge relative to the flocking material.

When the charge differential has been established, the flocking particles may be applied 150. The flocking material particles having a positive charge are drawn to the object with a negative charge (the grounded substrate) which is the object to be flocked. Due to the opposite charges of the particles and the substrate, the charged particles align vertically on the grounded substrate.

The embodiments described herein are illustrative of the present invention. As these embodiments of the present technology are described with reference to illustrations, various modifications or adaptations of the methods and or specific structures described may become apparent to those skilled in the art in light of the descriptions and illustrations herein. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A method of modifying identification signatures of an object comprising:
preparing flocking particles to be applied to the object,
applying adhesive to at least one selected area of the object, the selected area being chosen by a user to be covered with flocking particles to modify identification signatures of the object;
providing a charge differential to the flocking particles relative to the selected area of the object; and
applying the flocking particles to the selected area.

2. The method of claim 1 wherein the object comprises military equipment.

3. The method of claim 1 wherein the flocking particles are prepared by chopping a cord material into particles of a desired length.

4. The method of claim 3 wherein the cord material is manufactured with radar absorbent material embedded therein.

5. The method of claim 1 wherein the flocking particles comprise radar absorbent material.

6. The method of claim 1 wherein the adhesive comprises radar absorbent material.

7. The method of claim 1 wherein the flocking particles have varied lengths.

8. The method of claim 1 wherein the adhesive comprises paint.

9. The method of claim 8 wherein the paint comprises radar absorbent material.

10. A system for modifying identification signatures of an object comprising:
flocking material to be applied to the object, the flocking material being prepared according to requirements of a given application;
an electrostatic flocking apparatus, the apparatus comprising elements to create a charge differential between the flocking material and the object; and
an adhesive applied to at least one selected area of the object, the flocking material thereafter being applied to the selected area.

11. The system of claim 10 wherein the object comprises military equipment.

12. The system of claim 10 wherein the flocking material comprises flocking particles.

13. The system of claim 10 wherein the flocking material comprises radar absorbent material.

14. The system of claim 10 wherein the adhesive comprises radar absorbent material.

15. The system of claim 10 wherein the flocking material comprises particles of varying lengths.

16. The system of claim 10 wherein the adhesive comprises paint.

17. The system of claim 16 wherein the adhesive comprises paint.
